(19) United States
(12) Patent Application Publication
(10) Pub. No.: US 2018/0264875 A1
(43) Pub. Date: Sep. 20, 2018

(54) Cosmetic Brush Cleaner and Dryer

(71) Applicants: Ryan Mongan, Orange, CA (US); Simon Ghahary, Long Beach, CA (US)

(72) Inventors: Ryan Mongan, Orange, CA (US); Simon Ghahary, Long Beach, CA (US)

(21) Appl. No.: 15/924,140

(22) Filed: Mar. 16, 2018

Related U.S. Application Data
(60) Provisional application No. 62/472,418, filed on Mar. 16, 2017.
(60) Provisional application No. 62/640,017, filed on Mar. 8, 2018.

(51) Int. Cl. B44D 3/00

(52) U.S. Cl. CPC B44D 3/006

(57) ABSTRACT

In one example, we describe a method and system for cosmetic brush cleaning and drying. It solves all the problems mentioned for the other products in the industry. Our system cleans multiple brushes effectively at one time without user intervention. After cleaning, the device can be placed into a drying mode that dries the brushes many times faster than air-drying along. Also, a mechanism can be included that transitions the device from the cleaning mode to the drying mode without user intervention, thereby, creating a fully automated system. In addition, our system/example cleans brushes in only one minute. Our system has four sub-assemblies/sub-systems/main components: Power cord; Handle (which holds the makeup brushes during cleaning and drying); Base (which holds the cleaning solution); and Cradle (which fits between the base and the handle). Various examples and variations are also presented here.

### RELATED APPLICATIONS

This application is related and gets the benefit of the priority date and filing date of the 2 prior (provisional) U.S. patent application Ser. 62/472,418, filed 16 Mar. 2017, titled “Cosmetic Brush Cleaner and Dryer” and Ser. No. 62/640,017, filed 8 Mar. 2018, titled “Device for cleaning and drying of brushes”. All of the teachings of the provisional cases are incorporated herein, by reference, including all text, spec, figures, and appendices.

### BACKGROUND OF THE INVENTION

The cleaning of brushes has been a chore that people have attempted to solve with automated means for over a century. Tyler US586404A demonstrated a Bristle Washing Machine in 1897. The Tyler invention is in a class of inventions that perform adequately for robust brushes, such as some paint brushes, brooms, hair brushes and combs. These inventions all abrade the bristles or tines of the brush by frictional means against some other surface or structure. This strategy can work very well for removing the contaminants that still remain in the bristles, but when the bristles are very fine and delicate, this physical torture of the individual bristles renders them non-functional.

Many cosmetic brushes that are intended to apply makeup to a face or other body part are very delicate in nature. If the bristles on one of these brushes are bent or displaced/damaged/fallen off, the makeup cannot be applied evenly or uniformly, as desired. Cosmetic brushes can also be very expensive. Owners of cosmetic brushes may keep the expensive versions for 10 years or longer to maximize their investment in the brush.

Even cleaning these brushes very gently against another surface can damage the bristles over this extended period of time. This damage will manifest as fraying of the individual bristles, breaking of bristles, bending of bristles, or even changing the material property of the bristles (e.g. Modulus of Elasticity). In addition, some cosmetic brushes employ a foam element on the end as the applicator, instead of bristles. These foams are delicate and abrasion may have the possibility of cutting the foam or removing pieces from the foam. The following table lists inventions that all employ this technique and produce shortcomings that we intend to solve with this invention:

TABLE 1
List of patents/applications:

| Patent No. or SN | INVENTOR |
|---|---|
| U.S. Pat No. 586404A | Tyler |
| U.S. Pat No. 1542025A | Ballman |
| U.S. Pat No. 2082991A | Generoso |
| U.S. Pat No. 2354898A | Wiksten |
| U.S. Pat No. 2519259A | Liebman |
| U.S. Pat No. 3058134A | Wozniak-Rennek |
| U.S. Pat No. 3080591A | Townsend |
| U.S. Pat No. 4403364A | Schroeder |
| U.S. Pat No. 4823424A | Thatcher |
| U.S. Pat No. 4912797A | Brackett |
| U.S. Pat No. 5701626A | Zara |
| U.S. Pat No. 6666925B2 | Brackett |
| U.S. Pat No. 7086112B2 | Smith |
| U.S. Pat No. 7296319B2 | Brackett |
| U.S. Pat No. 7594291B1 | Carmen |
| U.S. Pat No. 20140096801A1 | McCormick |
| EP1723872A1 | Frassinelli |
| U.S. Pat No. 20100005604A1 | Esposito |
| U.S. Pat No. 9380860B1 | Taylor |
| U.S. Pat No. 9277805B2 | Baker |
| U.S. Pat No. 5652991A | Kashani |
| WO2017117170A1 | Premananda |

On the opposite end of the spectrum from the abrasion solutions are inventions that rely solely on the solvent property of the fluid and no relative motion between the brushes and the cleaning solution. Sica U.S. Pat. No. 5,097,967A and Custeau U.S. Pat. No. 4,865,188A both employ this strategy with paint brushes. While this may work for some applications, the disadvantages here are several. A solvent, which can be a dangerous element for skin contact or inhalation, needs to be utilized for oil based paints or cosmetics. The time frame to clean the brushes will need to be extensive, compared to the abrasion solutions and may extend into hours. Paint or contaminants that are loosened, but internal to the tuft of bristles, are not necessarily removed. The bristles need to be manually displaced at a minimum, and, more likely, worked thoroughly by hand in order to eliminate the paint that is still retained by the tuft of the bristles. Finally, while this is obviously gentler from a mechanical standpoint, the aggressiveness of the solvent can change the physical properties of the bristles over time.

Another class of solutions to this problem centers about ultrasonic cleaners. These cleaners agitate the fluid around the object to be cleaned. This high frequency agitation causes micro bubbles to appear in the fluid, which then collapse. The collapsing of the bubbles is actually what causes the cleaning effect by dislodging material attached to another medium.

While ultrasonic cleaners are effective for many applications, they have some shortcomings when it comes to cleaning brushes. First, the technology does not work well with absorptive materials, like sponges, which, as mentioned previously, can be on the applicator end of the brush. Second, the excited fluid does not tend to spread bristles apart. Because of this, it is difficult to remove material from the center of a tuft of bristles without doing a secondary operation of manually manipulating the bristles. Third, softer metals with a bright finish may lose their brilliance, if immersed in an ultrasonic tank.

In a typical cosmetic brush, the bristles are gathered together and glued inside a ferrule. This ferrule is a soft metal part which is then crimped onto the shaft of the brush. These ferrules are most often bright in luster. Fourth, heating of the fluid is a natural byproduct of running the ultrasonic system. While this improves the cleaning function for many parts, some cosmetic brushes are fragile and excessive heat can damage the bristles or the glue within the ferrule.

Finally, for ultrasonic cleaners to run at their peak efficiency, systems should be degassed prior to running parts. This is an extra step that might confuse users and, at the very least, burdens the user with extra steps. The following table lists inventions that all employ this technique.

TABLE 2
List of patents/applications:

| Patent No. or SN | INVENTOR |
|---|---|
| U.S. Pat No. 2994330A | Catlin |
| U.S. Pat No. 20100326484A1 | Wu |

Still another class of solutions uses liquid jets to clean the brushes. The following table lists inventions that all employ this technique. This novel solution relies on the incident angle of the jet with respect to the area being cleaned. This angle needs to be varied and the jet needs to impact every portion of the brush. Because of this, it is difficult to ensure that all shapes and sizes of brushes will be cleaned by the same automated system.

TABLE 3
List of patents/applications:

| Patent No. or SN | INVENTOR |
|---|---|
| U.S. Pat No. 3860021A | Saric |
| U.S. Pat No. 4823424A | Thatcher |
| U.S. Pat No. 4912797A | Brackett |
| U.S. Pat No. 5406967A | Sica |
| U.S. Pat No. 20120199168A1 | Campbell |

Another class of solutions employs a cleaning fluid and the device which continuously rotates the brush through the fluid at high angular velocities. This can be an effective cleaning strategy, but it has several shortcomings, which our invention intends to solve. First, when the axis of brush rotation is parallel to the direction of the brush bristles and the brush is spun at high speeds, the bristles can flare and bend dramatically at the ferrule. This can damage fragile bristles.

Second, as the brush rotates through the fluid in a continuous motion, the brush imparts energy to the fluid and gets the fluid up to speed in the same direction as the brush. This reduces the cleaning effectiveness as the relative speed difference between the brush and the fluid is decreased and the brush needs to be spun at an even higher speed to compensate.

Finally, once this fluid is moving, it takes up more space in the reservoir and the reservoir would have to be designed larger to compensate. For example, when the axis of rotation is perpendicular to the surface of the cleaning fluid, the fluid is put into a vortex. The outer regions of the fluid start to climb up the inside walls of the reservoir and the fluid at the center of the reservoir decreases in height, thereby exposing the bristles that are intended for cleaning. The following table lists inventions that all employ this technique.

TABLE 4
List of patents/applications:

| Patent No. or SN | INVENTOR |
|---|---|
| U.S. Pat No. 2286972A | Nash |
| U.S. Pat No. 2822814A | Torkelson |
| U.S. Pat No. 2832156A | Johnson |
| U.S. Pat No. 2853085A | Torke'son |
| U.S. Pat No. 2873463A | Nunes |
| U.S. Pat No. 2931661A | Harris |
| U.S. Pat No. 3116745A | Burning |
| U.S. Pat No. 3252174A | Schoepske |
| U.S. Pat No. 3399463A | Stott |
| U.S. Pat No. 4759384A | Kliewer |
| U.S. Pat No. 5107877A | Chipmen |
| U.S. Pat No. 5213121A | O'Brien |
| EP2430946B1 | Martinez |

The final class of solutions addresses the shortcomings of the just-mentioned continuously rotating class of solutions. These inventions oscillate the brushes back and forth in a cleaning solution, as taught by Schroder U.S. Pat. No. 2,239,741A and Olsen U.S. Pat. No. 2,449,818 A. This oscillation prevents the imparting of energy into the fluid as the fluid does not have the time to react, and these solutions can accommodate fragile brushes as they do not use the abrasion technique.

However, their shortcomings are two-fold. First, they can only accommodate a single brush at a time. Cleaning a large group of brushes will still be time consuming. Second, the solutions have the bristles co-linear with the axis of oscillation. Bristles very near the center will see very little motion. Because of this, the cleaning effectiveness will be dramatically reduced in this area, which is a disadvantage.

Another invention U.S. Pat. No. 6,821,355, Taylor et al., teaches the “Automatic eye wash cleaner”, which is very different from our inventions here below. Another prior art for design is US D 516257 S1, which does not teach our inventions/features, either.

Thus, none of the inventions above can solve all the problems mentioned above. So, we describe our inventions below, that solve all those problems above, not addressed by any or combination of the prior art, yet.

### SUMMARY OF THE INVENTION

Our invention/an embodiment solves all the problems mentioned above. Our invention/an embodiment cleans multiple brushes effectively at one time without user intervention. After cleaning, the device can be placed into a drying mode that dries the brushes many times faster than air-drying along. Also, a mechanism can be included that transitions the device from the cleaning mode to the drying mode without user intervention, thereby, creating a fully automated system. In addition, our invention/an embodiment cleans brushes in only one minute. Our invention/an embodiment has four sub-assemblies/sub-systems/main components:
Power cord
Handle (which holds the makeup brushes during cleaning and drying)
Base (which holds the cleaning solution)
Cradle (which fits between the base and the handle)

### BRIEF DESCRIPTION OF THE DRAWINGS

FIG. 1 is for one embodiment of our system, as an example, for its components shown.

FIG. 2 is for one embodiment of our system, as an example, for cradle sitting on top of base.

FIG. 3 is for one embodiment of our system, as an example, for handle being inverted for brush loading.

FIG. 4 is for one embodiment of our system, as an example, for brush loading.

FIG. 5 is for one embodiment of our system, as an example, for brushes loaded.

FIG. 6 is for one embodiment of our system, as an example, for cross sectional view, from section A-A direction.

FIG. 7 is for one embodiment of our system, as an example, for cross sectional view, from section B-B direction.

FIG. 8 is for one embodiment of our system, as an example, for handle being inserted for drying position.

FIG. 9 is for one embodiment of our system, as an example, for handle being fully inserted for drying position.

FIG. 10 is for one embodiment of our system, as an example, for pressing the power button to activate the oscillating motion.

FIG. 11 is for one embodiment of our system, as an example, for handle on brush holder.

FIG. 12 is for one embodiment of our system, as an example, for cleaning fluid in base.

FIG. 13 is for one embodiment of our system, as an example, for applicator immersed in cleaning fluid.

FIG. 14 is for one embodiment of our system, as an example, for handle shown in drying position.

FIG. 15 is for one embodiment of our system, as an example, for processor controlling motor, display, and UV light, as extra options.

FIG. 16 is for one embodiment of our system, as an example, for processor controlling motor, fan, and UV light, as extra options.

FIG. 17 is for one embodiment of our system, as an example, for processor controlling cleaning, heater, fan, and UV light, as extra options.

FIG. 18 is for one embodiment of our system, as an example, for processor controlling cleaning, timing, and charging, as extra options.

### DETAILED DESCRIPTION OF THE PREFERRED EMBODIMENTS

To solve the above problems, we teach the following inventions and embodiments, with some examples:

Cosmetic brushes (aka makeup brushes) are a tool used to apply, spread and blend various powders, gels and liquids on the skin (as shown in our Figs.). The brushes are typically comprised of three major components. There is a shaft that the user holds onto. At the far end is the applicator. This is typically a foam, elastomer or bristles. If they are bristles, they are sometime synthetic and sometimes natural (animal fur). Between the bristles and the shaft is a ferrule. The ferrule is often a piece of ductile metal that has been crimped onto the shaft.

The applicator is then inserted into the other end the ferrule and is held by either crimping or gluing. Some brushes are double ended and have ferrules and applicator on both ends of the shaft. The variety of different applicators is immense. Not only does stiffness vary, different overall sizes, shapes and various end conditions are all available. Smaller applicators are generally paired with smaller shafts to allow for detail work around areas, such as the eyes. Large applicators are for applying makeup over a larger area and are generally paired with larger diameter shafts.

After being used, residual makeup remains on the applicator. This needs to be cleaned from the applicator prior to using it with another makeup to avoid contamination. In addition, gel or liquid based makeup will dry on the applicator rendering the brush useless. An individual may use 6 brushes or more in one sitting to apply makeup. This creates a cleaning chore that is labor intensive. Because of this, the cleaning is often rushed through or neglected altogether. Even when brushes are cleaned, the cleaning is typically done with a fluid which leaves the applicator wet after cleaning. The user needs to wait until the applicator dries, in order to use the same brush again properly. Using a damp brush with many makeup formulations, especially powder, is not possible because the powder is not spread properly with a damp brush.

Currently, brushes are either cleaned by hand or in a semi-automated manner. When cleaned by hand, several different techniques are employed. Some users apply a cleaning solution (often alcohol or hydrocarbon based) directly on the applicator using a spray bottle (see our Figs.). The bristles are then wiped with a towel to remove the majority of the cleaning solution and the makeup that is made mobile due to the wetting. This is a labor-intensive process, as only one brush can be cleaned at a time by a single user. That user needs to often make multiple applications of the cleaning fluid in order to keep the makeup mobile. The user keeps repeating this process until they can see the makeup is removed from the brush.

Sometimes, it is difficult to distinguish the color of the applicator and the makeup itself. In that case, the user either needs to guess on when it is cleaned adequately, or the user needs to constantly use a clean, visually contrasting towel so they can see when makeup is no longer being removed. Even in the case that the makeup is a different color than the applicator, the user still has to take a guess when the brush is cleaned adequately. Makeup is often not visible on the interior of the applicator between bristles or at the intersection of the applicator and the ferrule.

Another manual technique involves the use of a cleaning pad, in addition to the cleaning fluid (see our Figs.). Here, a makeup brush is wet with cleaning fluid, and then abraded against a surface (typically silicone) that helps to remove the makeup. This does tend to dislodge more makeup than wiping with a towel along. However, the brush still needs to be wiped with a towel after using the cleaning pad to remove more makeup and to decrease the fluid load in the applicator and reduce the drying time.

Both this solution and the one prior to that suffer from a shortcoming that someone needs to manually do the process from the start to finish. They also can only clean one brush at a time. Also, physically abrading the applicator can sometimes bend or break bristles, making the brushes less than fully functional.

Currently, on the market, there is one semi-automated solution that addresses the first two of these manual cleaning shortcomings. The device is marketed under the name Lilumia (see our Figs./Appendices), and is described by U.S. Pat. No. 9,380,860. Here, a carousel of brushes is loaded up, and cleaning fluid is stored in the base. The brushes are adjusted vertically until they are touching a cleaning mat. A thin layer of cleaning solution is added to the cleaning mat and the carousel is oscillated slowly back and forth, dragging the applicators across the mat. The manufacturer of the invention is careful to educate the user to not press the applicators too forcefully against the mat to avoid the aforementioned applicator damage (see our Figs./Appendices). While this will help to minimize damaging the brushes, any physical contact can damage the bristles. In addition, since cleaning solution is only in a thin layer on the mat, only the ends of the brushes that are touching the mat are cleaned. After cleaning, the carousel is raised, and the brushes are allowed to air-dry similar to the manual technique.

Still, another semi-automated solution involves the user of an ultrasonic cleaner (see our Figs./Appendices). Here the brush shafts are held by the lid. The base of the ultrasonic cleaner is filled with water, and when the lid is closed, the applicator ends submerge in the fluid. This has the possibility of solving all the aforementioned problems: many brushes can be cleaned at once, the user does not need to be present and the applicator ends are not abraded against another surface, and since the entire applicator can be submerged, the cleaning efficacy could be greater than the Lilumia invention.

However, in practice, the cleaning with this invention is sub-optimal for two reasons. First, the cleaning solution needs to be water only. Water cannot remove the oil-based liquids and gels from the makeup brushes. It is only effective with a powder-based makeup. The reason why water must be used exclusively is that the ultrasonic cleaner is not an explosion-proof model. The ultrasonic's action on the fluid in the tank and the presence of the requisite high voltage just under the tank in the driver electronics create an explosion possibility. There are explosion-proof ultrasonic cleaning baths, but even small versions of these quickly climb to over $1000 in cost (see our Figs./Appendices).

The second reason that this solution is not very effective is that the consumer grade ultrasonic cleaner in the invention is just not powerful enough. Ultrasonic cleaners, by definition, operate at frequencies over 20,000 cycles/second. Many in the market operate around 40,000 cycles/second. At a given frequency, variations in wattage are represented as variations in amplitude. Low wattage cleaners, such as this invention, have very little amplitude of displacement. This may work adequately for rigid items like jewelry, but they do not work well for compliant members, like the applicators. To clean a compliant applicator, a higher frequency ultrasonic cleaner needs to be employed. These get large and expensive very quickly (see our Figs./Appendices).

In addition to the problems mentioned above, none of the existing solutions address the following challenges:
Drying at a rate faster than air-drying
A fully automated version that can take a brush all the way through to a clean and dry state

Our invention cleans multiple brushes effectively at one time without user intervention. After cleaning, the device can be placed into a drying mode that dries the brushes many times faster than air-drying along. Also, a mechanism can be included that transitions the device from the cleaning mode to the drying mode without user intervention, thereby, creating a fully automated system. In addition, our invention cleans brushes in only one minute. The Lilumia solution is a 15-minute cycle, and the ultrasonic cleaner runs on a 10-minute cycle, and is recommended to run 2-3 times by the manufacturer.

Our invention has four sub-assemblies/sub-systems/main components (see our Figs./Appendices):
Power cord
Handle (which holds the makeup brushes during cleaning and drying)
Base (which holds the cleaning solution)
Cradle (which fits between the base and the handle)

The power cord converts AC power to DC power that is utilized in the device.

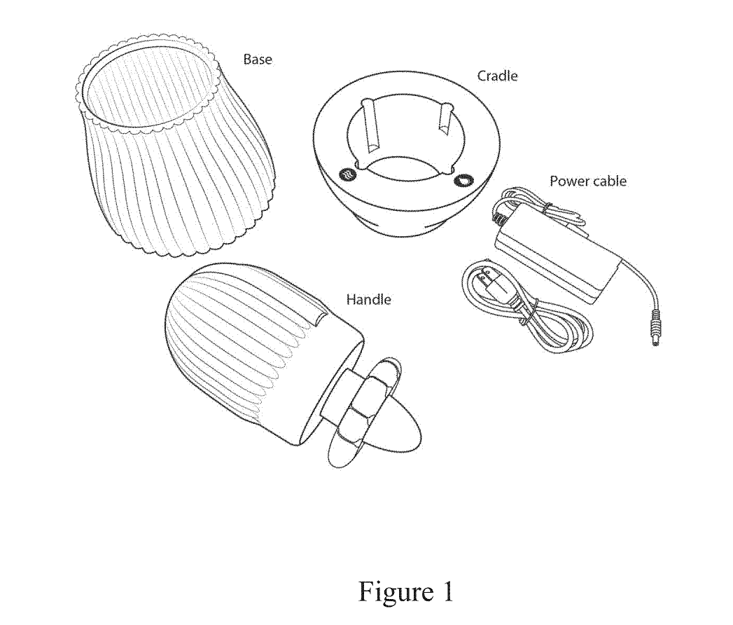

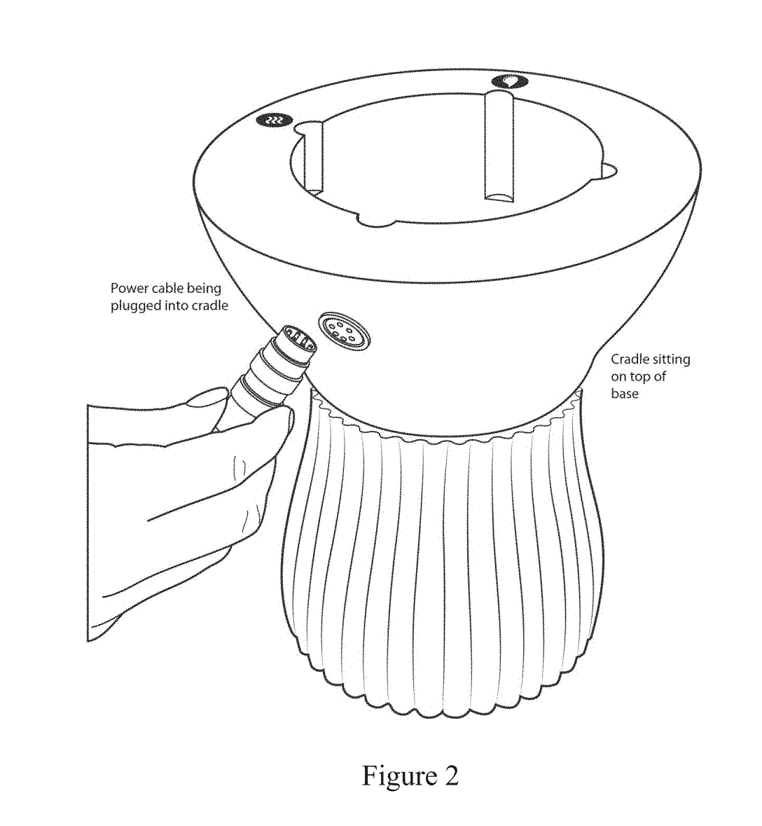

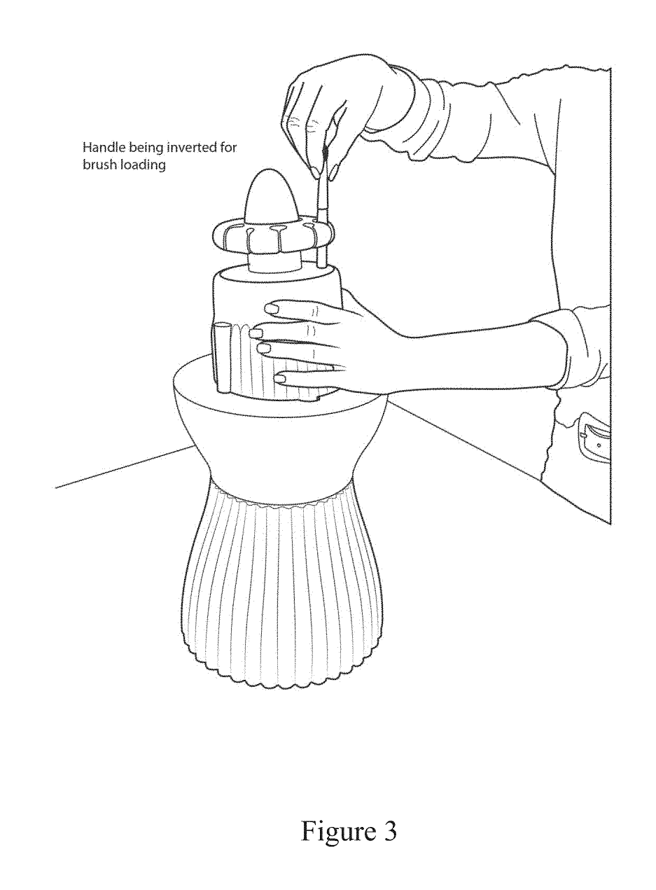

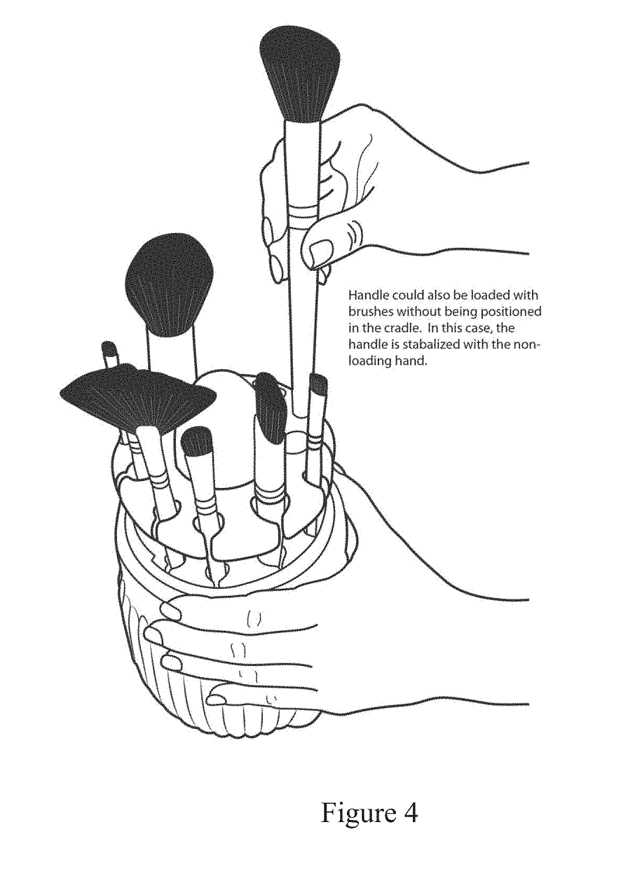

Here are some examples/embodiments: FIG. 1 is for one embodiment of our system, as an example, for its components shown. FIG. 2 is for one embodiment of our system, as an example, for cradle sitting on top of base. FIG. 3 is for one embodiment of our system, as an example, for handle being inverted for brush loading. FIG. 4 is for one embodiment of our system, as an example, for brush loading.

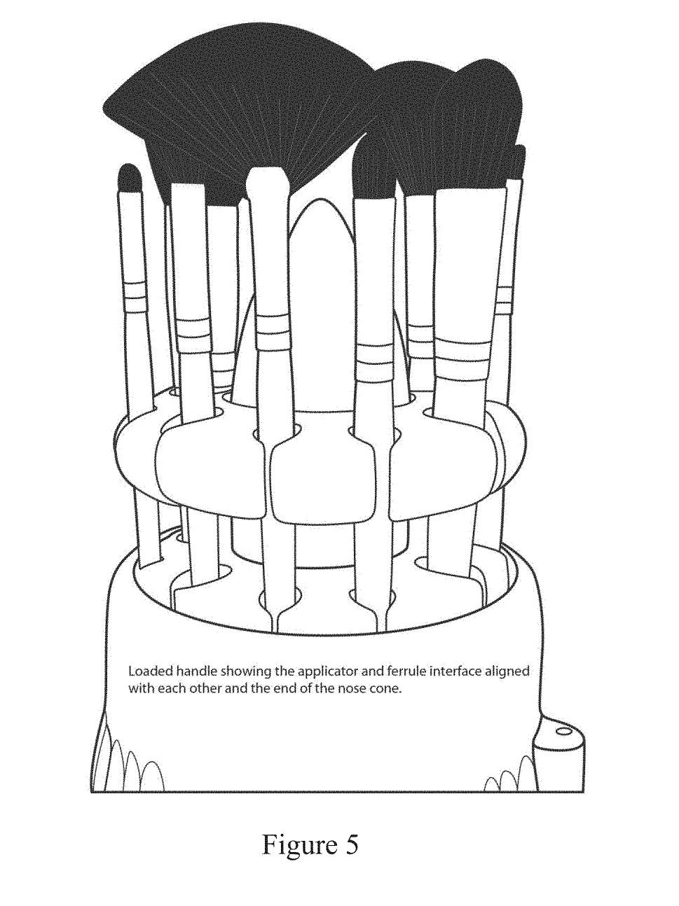

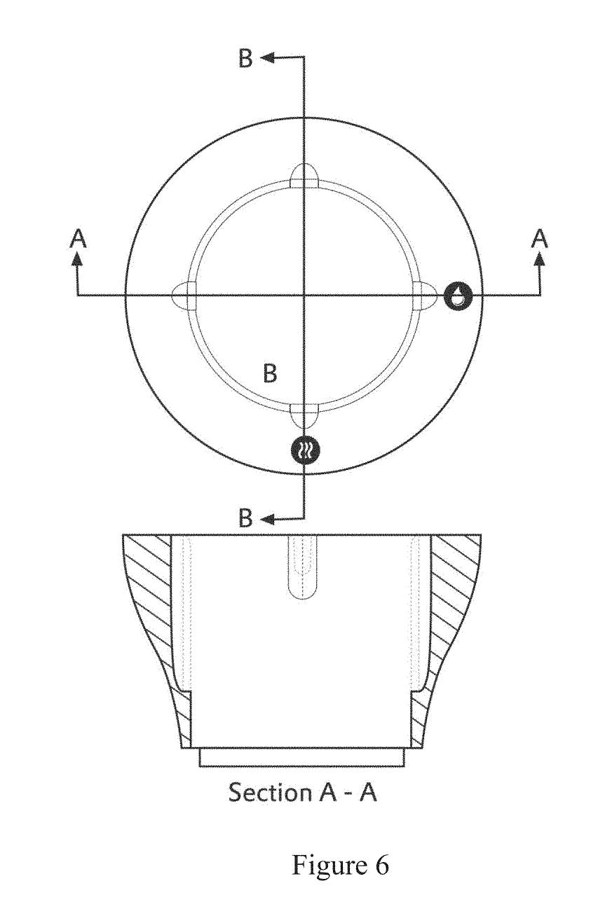

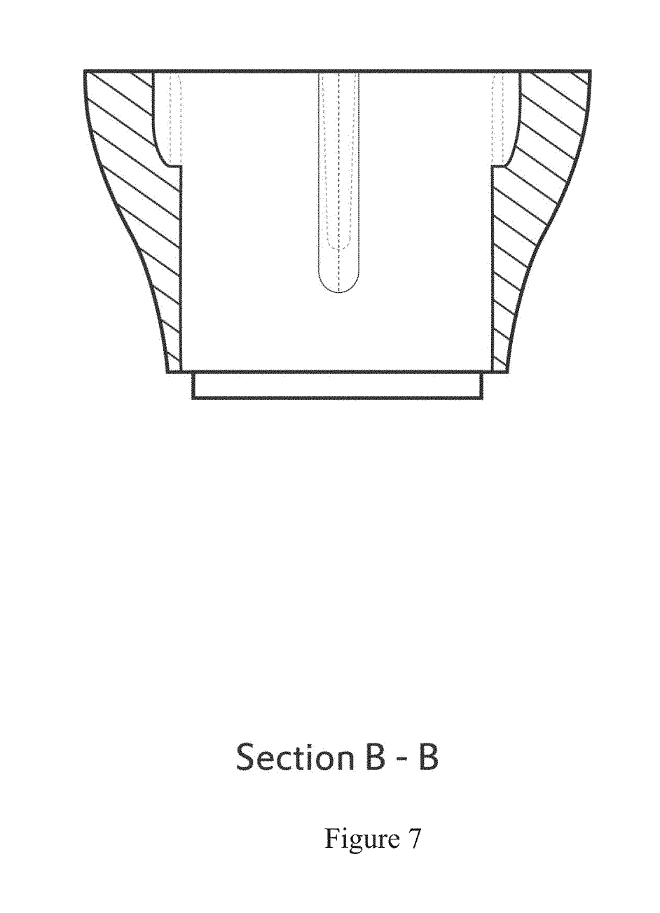

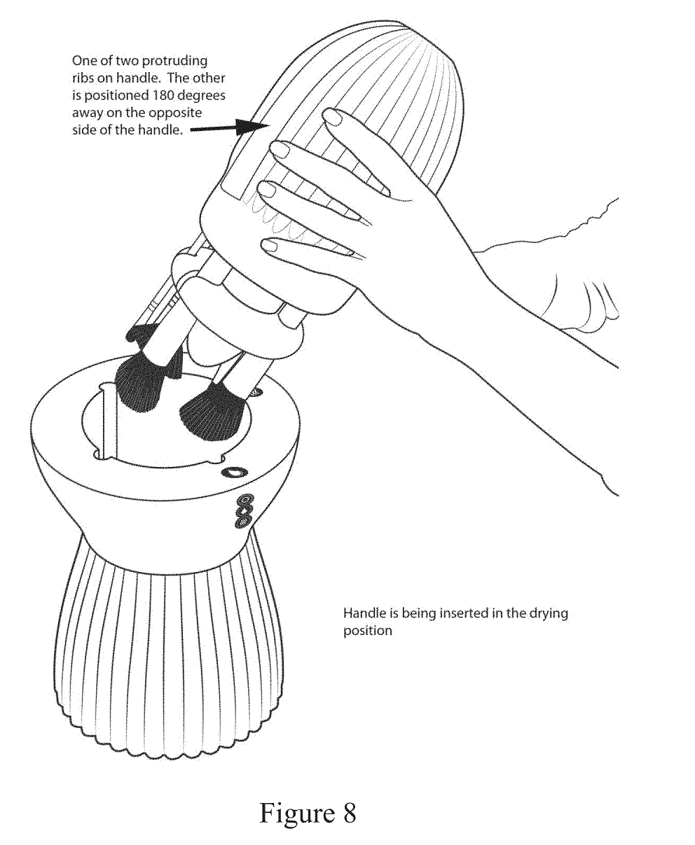

FIG. 5 is for one embodiment of our system, as an example, for brushes loaded. FIG. 6 is for one embodiment of our system, as an example, for cross sectional view, from section A-A direction. FIG. 7 is for one embodiment of our system, as an example, for cross sectional view, from section B-B direction. FIG. 8 is for one embodiment of our system, as an example, for handle being inserted for drying position.

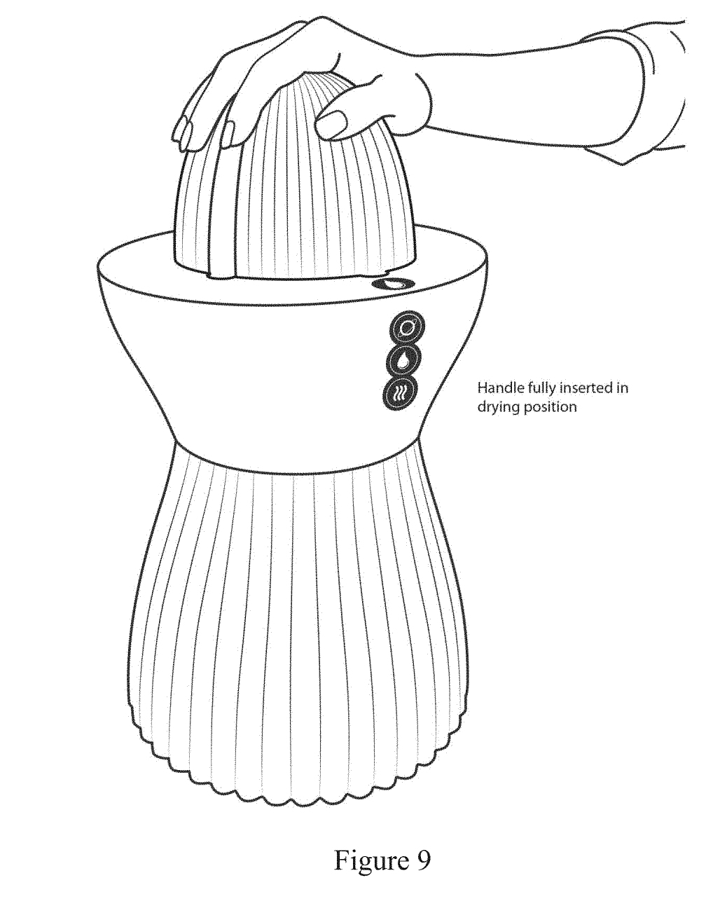

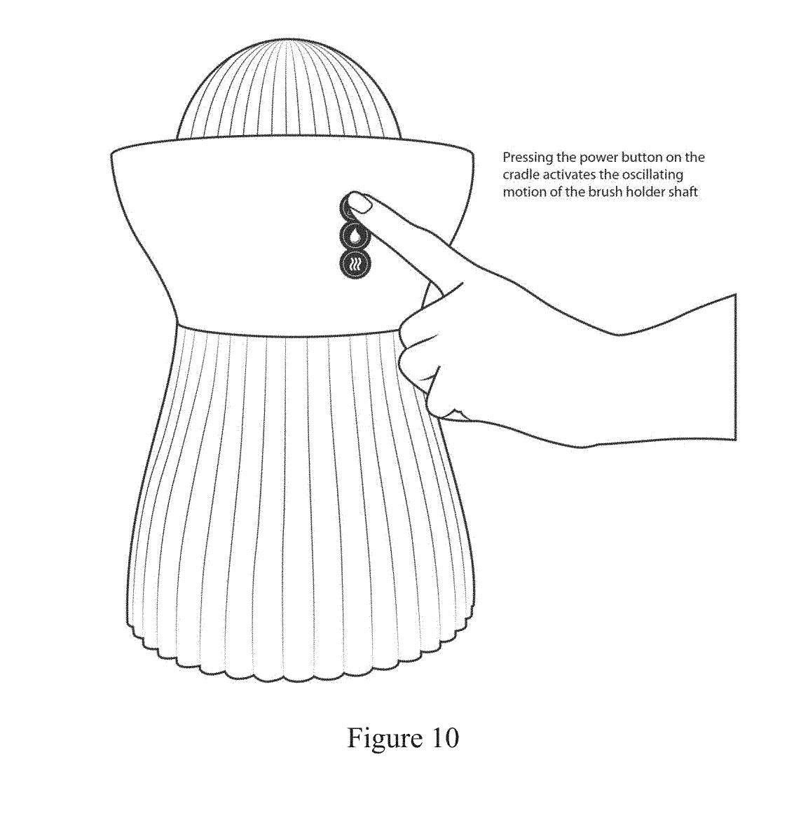

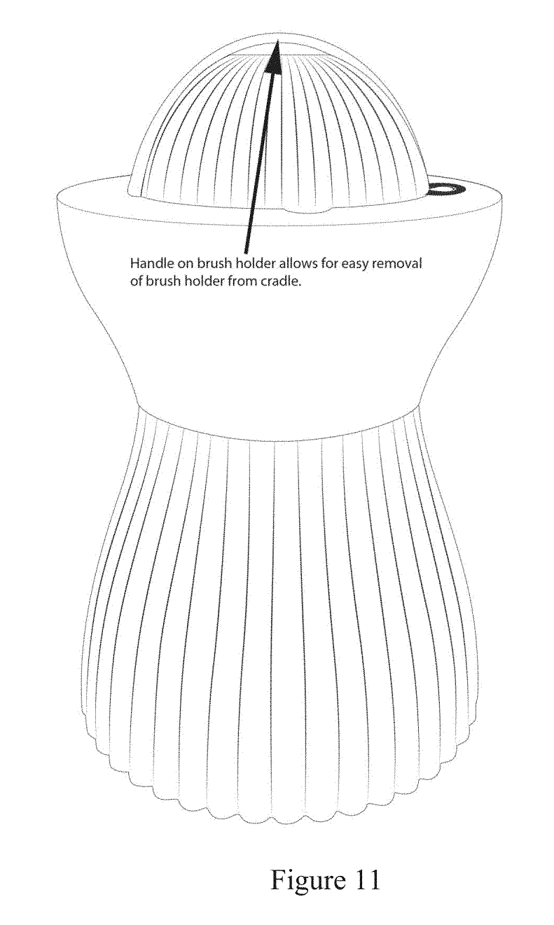

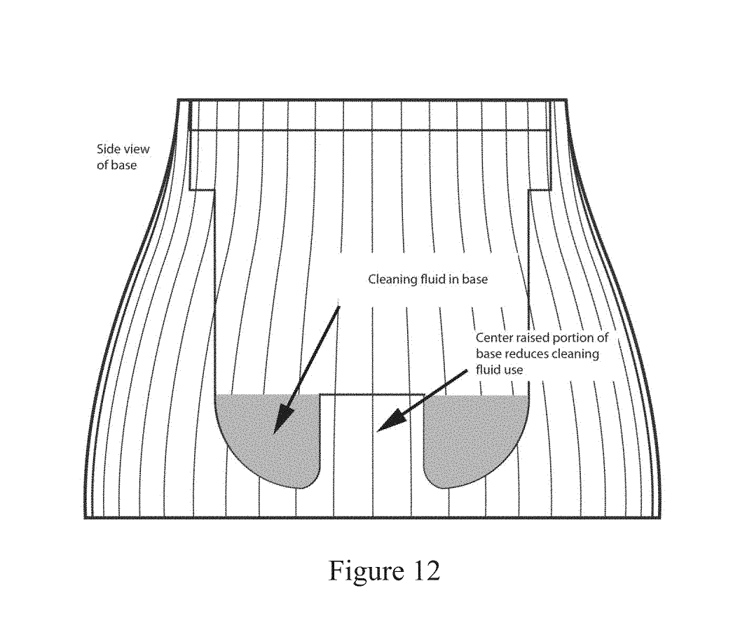

FIG. 9 is for one embodiment of our system, as an example, for handle being fully inserted for drying position. FIG. 10 is for one embodiment of our system, as an example, for pressing the power button to activate the oscillating motion. FIG. 11 is for one embodiment of our system, as an example, for handle on brush holder. FIG. 12 is for one embodiment of our system, as an example, for cleaning fluid in base.

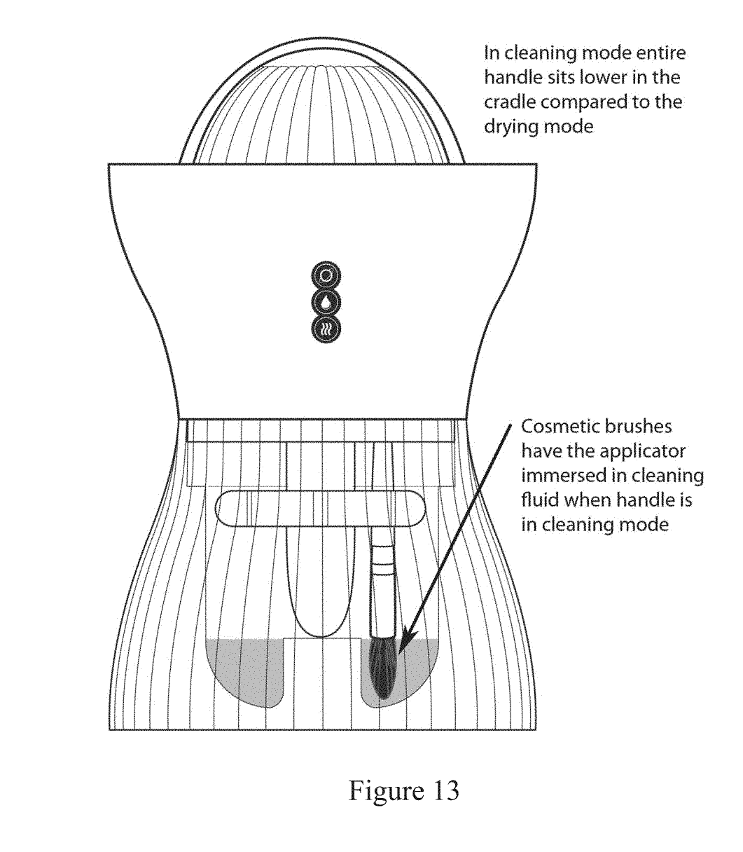

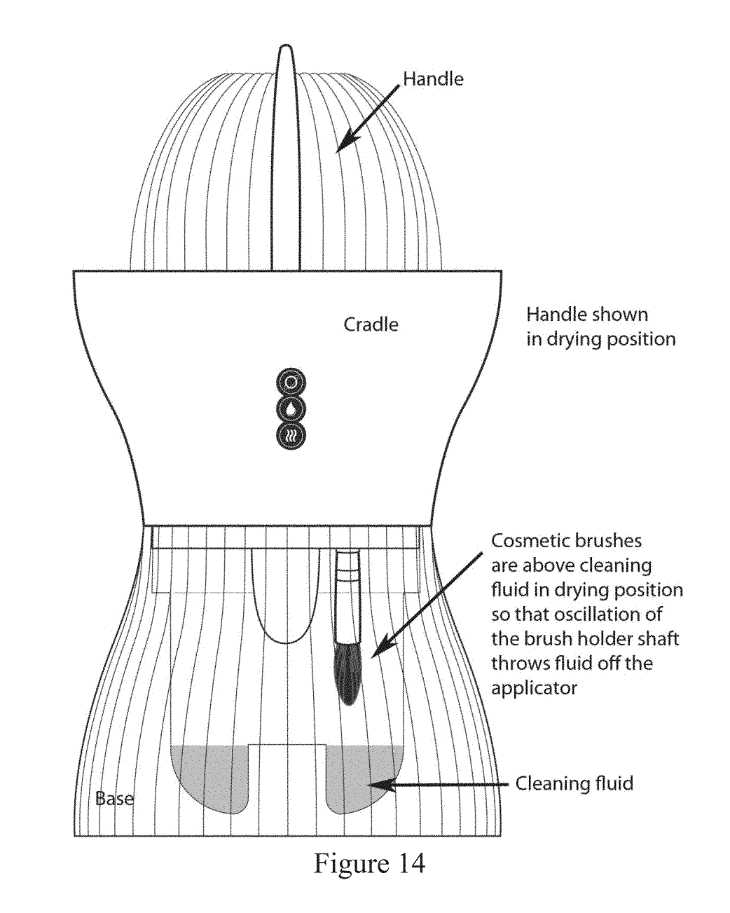

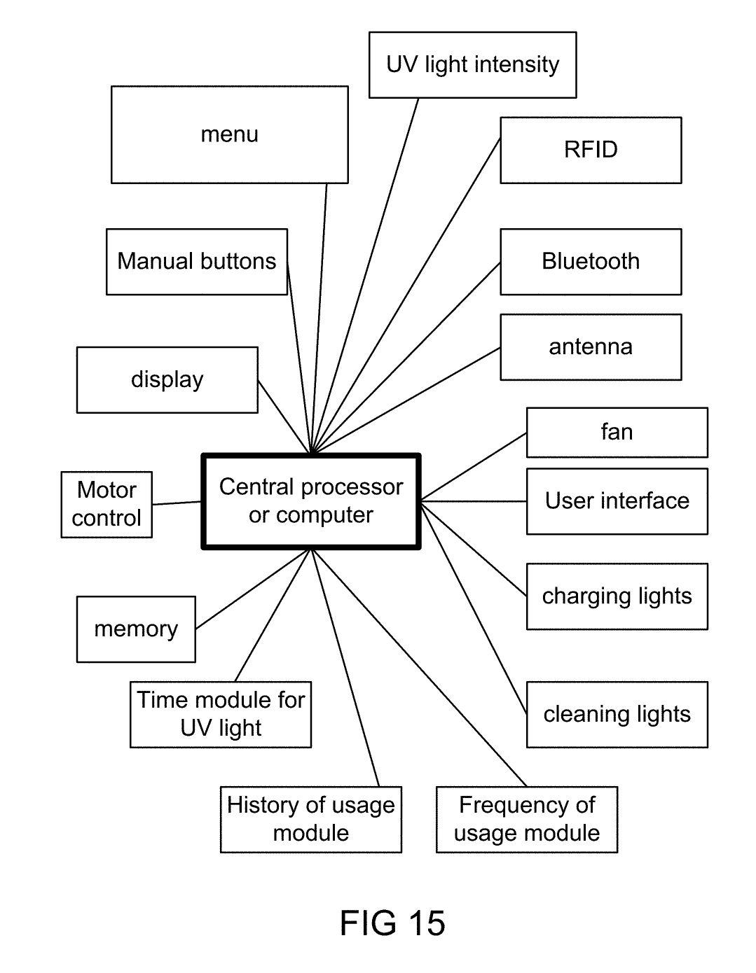

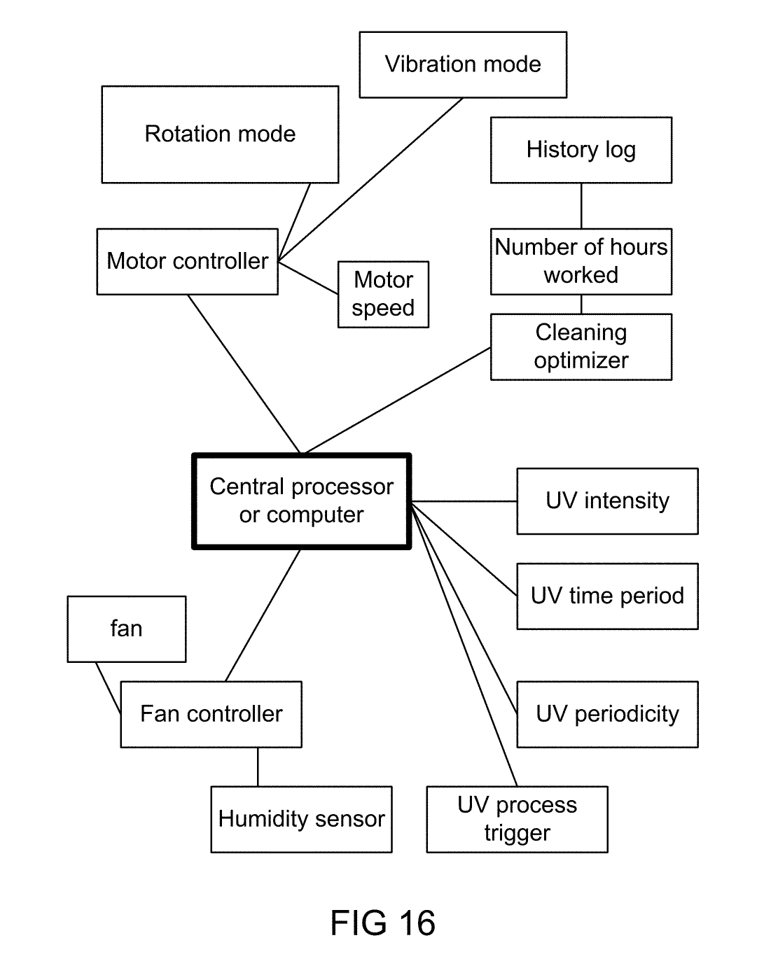

FIG. 13 is for one embodiment of our system, as an example, for applicator immersed in cleaning fluid. FIG. 14 is for one embodiment of our system, as an example, for handle shown in drying position. FIG. 15 is for one embodiment of our system, as an example, for processor controlling motor, display, and UV light, as extra options. FIG. 16 is for one embodiment of our system, as an example, for processor controlling motor, fan, and UV light, as extra options.

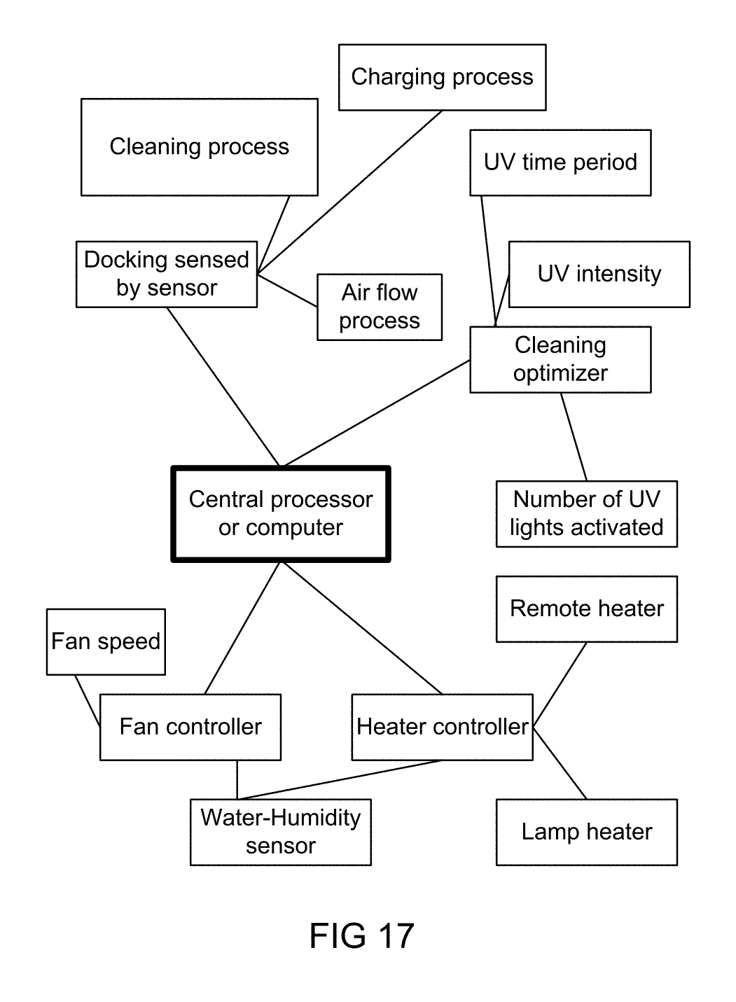

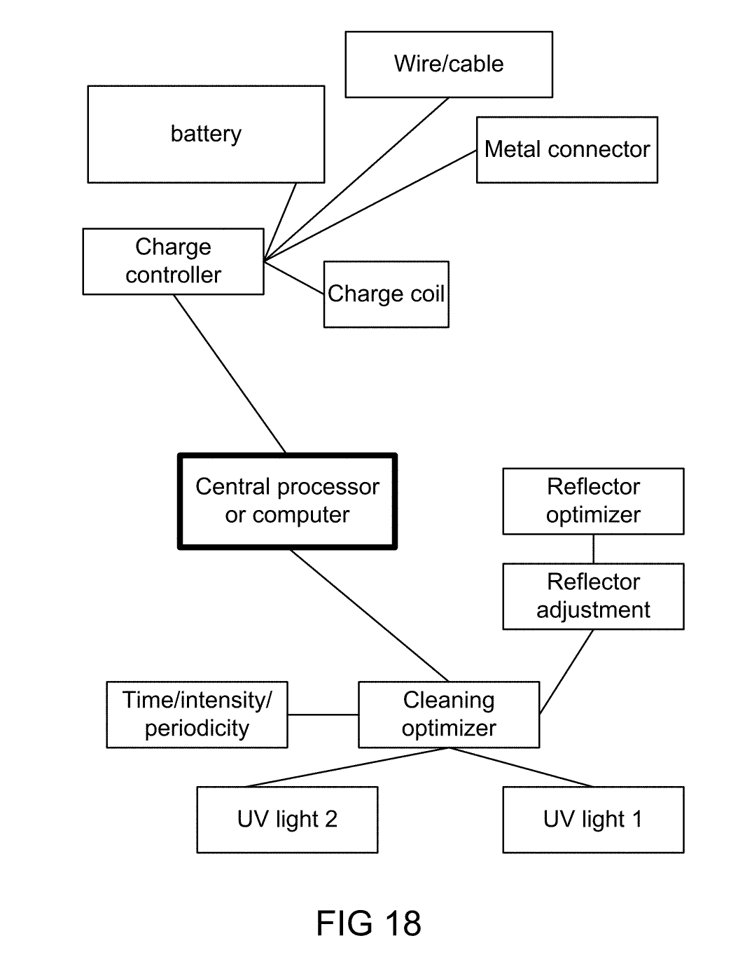

FIG. 17 is for one embodiment of our system, as an example, for processor controlling cleaning, heater, fan, and UV light, as extra options. FIG. 18 is for one embodiment of our system, as an example, for processor controlling cleaning, timing, and charging, as extra options.

Appendix 1 has the following examples: Page 1 shows the complete system with handle, holder, base, gasket, and finger grab area. Page 2 shows the power socket. Page 3 shows another view of the power socket. Page 4 is the back view. Page 5 is also the whole system. Page 6 is holder and base. Page 7 is handle. Page 8 is handle. Page 9 is handle. Page 10 is base. Page 11 is handle and loading. Page 12 is positioning the brush. Page 13 is loading. Page 14 is loading and securing. Page 15 is wrap strap.

Appendix 1, Page 16 is strap. Page 17 is base. Page 18 is rib, alignment, and groove. Page 19 is power button and cleaning activation. Page 20 is cleaning. Page 21 is loading and draining. Page 22 is different types of brushes. Page 23 is one type of cleaning. Page 24 is one type of cleaning. Page 25 is one type of system. Page 26 is one correct way of cleaning. Page 27 is one type of system. Page 28 is one type of system, explosion proof ultrasonic cleaner. Page 29 is one type of system and our system. Page 30 is our system.

Appendix 1, Pages 31-50 are inside mechanical components and assembly together. Pages 51-64 are similar to those in FIGS. 1-14, as described above.

Appendix 2, Pages 1-24 are the 3 components of the system in various assembly or positions with respect to each other (i.e., handle, holder, and base, as shown from left to right, on Page 1, as separated from each other). This is one design type of the system, corresponding to/for one embodiment of the invention.

The handle has electronic contact pads that touch off on compliant pins in the cradle. (Alternatively, the handle can have the compliant pins, and the cradle can have the static contact pads.) The contact pads in the handle are wired to a DC motor. This motor spins a shaft to which an off-center bearing is attached. The center of the bearing is tracing a small circle, due to its off-center mounting. Straddling the outer race of the bearing is a fork. This fork is only acted upon by the bearing in one axis. So, the combination of the bearing and the fork convert the rotational movement of the motor to an oscillating quasi-linear movement. The motion is quasi-linear, since the fork has its own rotational center at a distance from the off-center bearing.

A brush holder shaft is attached to the fork rotational center. Also, because the end of the fork touching the off-center bearing is moving back and forth, this creates a small amplitude of rotational movement of the brush holder shaft, on the order of within 5 degrees, or the like. This can have a range from 1 degree to 30 degrees. This brush holder shaft extends below the handle housing.

Attached to the brush holder shaft is an elastomeric brush holder. The brush holder is elastomeric so that it is compliant and can accommodate a wide variety of brush handle diameters. A second elastomeric brush holder is attached to the handle housing, fixing the brush shafts distal to the applicators. The moving elastomeric brush holder is attached to the brush shafts very close to the ferrules. This allows the applicators to oscillate back and forth along with the brush holder shaft. The brush holder is elastomeric since that offers compliance to accommodate a variety of brush sizes and prevents the brushes from slipping during the cleaning cycle.

The entirety of the brush holder can be comprised of an elastomeric element (see our Figs./Appendices; Appendix 1), or it can be comprised of elastomeric elements such as a gasket and a strap (see our Figs./Appendices; Appendix 1), to achieve the same goal. Our Figs. demonstrate how multiple brushes can be loaded into such a brush holder.

The base is a reservoir that holds the cleaning solution (see our Figs./Appendices; Appendix 1). It can be separated easily from the cradle, allowing it to be carried to a sink, where the cleaning solution can be dumped out (see our Figs./Appendices; Appendix 1).

The cradle (also known as the holder) takes power in from the power cord and attaches it to a variety of control switches and lights. It also attaches the power to the previously mentioned compliant pins which the handle touches off. The cradle contains electronics to control the timing of the cleaning and drying cycles, and in the fully automated version, controls the activation between the two cycles.

In the semi-automated version, the cradle contains sensors (e.g. physical switches or Hall effect sensors) that can determine which position the handle is in, cleaning or drying. In the case of Hall effect sensors, magnets can be included in the handle to energize the sensors which communicates to the cradle which position the handle is in. The cradle sits on top of the base during normal operation. In order to keep the cleaning fluid from leaking from this interface and to keep the cradle and base from rotating with respect to one another, a compliant gasket can be positioned between the two parts (see our Figs./Appendices; Appendix 1).

Figures (Appendix 1) show the components and how the device is used in a semi-automated manner.

As shown, when the makeup brushes are loaded into the handle, the end of the ferrule next to the applicator is aligned with the end of the brush holder shaft. This ensures that when the handle is placed in the cradle in the cleaning position, the applicators are immersed in the cleaning solution. Also, when the handle is placed in the drying position, the applicators are in the air above the cleaning solution. The drying position can be accomplished by aligning the protruding ribs of the handle with a pair of short recesses, or the ends of the protruding ribs can rest on top of the cradle.

Alternatively, the drying can be accomplished via air-drying, outside of the cradle and base, if the handle includes or can be mated with a stand (see our Figs./Appendices; Appendix 1). This stand can also assist the user with the proper placements of the applicator end of the makeup brushes. The stand and the brush holder in combination can comprise a bristle zone (see our Figs./Appendices; Appendix 1). This bristle zone ensures immersion of the applicator in the cleaning solution during the clean cycle and ensures the applicator is clear of the cleaning solution during the dry cycle.

Figures demonstrate how the two positions are achieved (cleaning and drying). The cradle possesses two pairs of recesses. These recesses accommodate the protruding ribs on the handle. When the protruding ribs are aligned with the recesses where the section A-A runs through, the handle can sit low in the cradle, since the recesses are long. This plunges the applicators into the cleaning fluid in the base and allows for cleaning (see our Figs./Appendices; Appendix 1).

When the protruding ribs are aligned with the recesses where the section B-B runs through, the handle sits high in the cradle, since the recesses are short. This raises the applicators out of the cleaning fluid in the base and allows for the drying cycle (see our Figs./Appendices; Appendix 1).

Alternatively, the second set of recesses could be eliminated (see our Figs./Appendices; Appendix 1), leaving a single set of recesses in the cradle 180 degrees apart (see our Figs./Appendices; Appendix 1). To move from this cleaning position to the drying position, the handle is removed from the cradle and rotated slightly. It is then put back down on top of the cradle, ensuring that the locating ribs are mis-aligned with the recesses in the cradle.

The ends of the locating ribs surrounding the power contact target (see our Figs./Appendices; Appendix 1) then sit on the upper surface of the cradle, rather than sliding into recesses. This allows the handle to sit high off the table surface, and raises the applicators out of the cleaning fluid, and the brushes can be allowed to air-dry without any activation of a mechanism. Without a powered drying cycle, the controls on the invention could be simplified. One embodiment of this would be a single button to engage the cleaning cycle and an indicator light that shows that the cycle is ongoing (see our Figs./Appendices; Appendix 1).

When cleaning and drying, the brush holder shaft and, by extension, the brushes, oscillate between 1,500 and 3,500 times per minute. The brushes have a translation of approximately 3-7 mm. Currently, the cleaning and drying frequency are the same, but running the motor in the handle faster or slower could have these cycles perform at different parameters. So, we can change those parameters in another embodiment.

Currently, the cleaning cycle time is set at one minute and the drying cycle time is set at 10 minutes. However, we can change those parameters in another embodiment, between 5 sec to 25 minutes, as an example, for range of time periods. Once these cycles are complete, the oscillation ceases. This stopping communicates to the user that the cycle is complete. Alternatively, lights and indicators or beeping sounds, or alarm or notice the watch or phone or loT or wearable or mobile device, or on the system, can communicate to the user where the system is in its cycle/its status.

One embodiment is: A cosmetic brush cleaner and dryer system, said system comprising: a handle; a holder; a base; wherein said handle holds one or more brushes of different sizes; wherein said handle is located on top of said holder; and wherein said holder is located on top of said base.

One embodiment/option is:
wherein said system comprises: locating rib.
wherein said system comprises: handle groove.
wherein said system comprises: an alignment mechanism.
wherein said base contains cleaning fluid or liquid or pod.
wherein said base contains water.
wherein said system comprises: a strap stud.
wherein said system comprises: a strap.
wherein said system comprises: a strap hole.
wherein said system comprises: makeup brush groove.
wherein said system comprises: makeup brush bristle zone.
wherein said system comprises: a handle stand.
wherein said system comprises: a sound indicator or a warning signal module connected to a mobile device.
wherein said system comprises: a wash indicator LED or light.
wherein said system comprises: finger grab area.
wherein said system comprises: a fork and a spindle.
wherein said system comprises: a bearing and a shaft.
wherein said system comprises: a motor or agitator or vibrator or oscillator.
wherein said system comprises: an off-center bearing and an off-center shaft.
wherein said system comprises: a UV lamp or other light or heat sources for cleaning or drying.

Assembly of the Handle:

Figures (Appendix 1) show the step by step assembly of the handle. Through these figures, the method of achieving the oscillating motion can be seen (see Figs.; Appendix 1). Alternatively, if this mechanism is rotated 90 degrees, the brush holder shaft can move in a pendulum motion producing a quasi-linear motion in the base (see Figs.; Appendix 1), rather than an oscillating rotational motion about the brush holder shaft. Still, another way to move the applicator ends would be in a vertical oscillation (see Figs.; Appendix 1).

This motion could be achieved by attaching another link to the stated 90-degree rotated motor assembly to constrain the motion in an up-down direction. Alternatively, this up-down oscillation could be achieved by a linear actuator, such as a solenoid. The brush holder shaft could be the shaft of the solenoid, while the solenoid housing could be contained within and secured to the handle.

### ALTERNATIVE EMBODIMENTS

Power could be supplied to the device directly in an AC manner. Then, a transformer in the device would convert this into different DC voltages, to be used throughout the device.

The elastomeric brush holder that is fixed to the handle housing could alternatively be attached to the brush holder shaft, similar to the other elastomeric brush holder. This would allow the brushes to move in unison from the shaft all the way to the applicator.

There could only be a single elastomeric brush holder that is attached to the brush holder shaft.

The cradle has the connector for the power cord, allowing the handle to be cord free. Alternatively, the cradle could be eliminated by combining the cradle and the base. In this case, the power cable would plug into the base. Controls would be on the base and power would be transferred from the base to the handle.

A UV-C lamp could be included in the base or in the cradle, in order to sterilize the brushes after cleaning.

The cleaning is currently shown to be offered in a concentrate form. It is combined with water in the base prior to the cleaning cycle. This is to reduce packaging volume and shipping cost. Alternatively, the solution could be supplied in a pre-mixed format for convenience. Another manner in which the cleaning solution could be offered in concentrate form is in the manner of a pod (see Figs.; Appendix 1). These pods, which are also known in the field as laundry pods, contain a cleaning solution surrounded by a water-solvable film, typically Polyvinyl Alcohol or PVA.

The invention could be supplied in a fully automated version, where no user intervention is required between the cleaning and drying cycles. This could be accomplished by lifting the entire handle upward between the cycles, or by translating upward the elastomeric brush holders within the handle. Either of these could utilize a solenoid or a linear actuator to achieve the motion.

An actuator could reside in the cradle and act upon the handle housing to lift it. Or, an actuator could reside in the handle housing itself, and translate upward the central shaft that is attached to the elastomeric brush holders. Still, another way would be to use the motor in the handle itself to perform double duty. It could create the oscillating motion to clean and dry the brushes, as well as create a translating mechanism to move the shaft containing the elastomeric brush holders up and down.

Since the handle comprises a motor and an oscillating element and the cradle is static, in order to reduce vibration and noise, a compliant member can exist between the two. This compliant member or rib soft insert (see Figs.) can be included on the protruding locating rib of the handle. It could also exist in the inside diameter of the cradle, in the locating rib recesses of the cradle, the main body of the handle, or a combination of these locations.

In order to minimize the overall size of the invention, the mechanism inside of the handle that creates the oscillating motion may necessitate the brush holder shaft to be positioned off-center to the center of mass of the handle. In this case, if a stand is used, the foot of the stand can be centered about the center of mass, rather than the center of the shaft (see Figs., Appendix 1). In Figs., this is shown by the red arrow, being bisected by the center line that runs through the center of mass of the handle. This provides greater stability for the system.

In one embodiment, we can use plastic, PVC, elastic, transparent, translucent, or opaque materials, or metal, alloy, carbon fiber, crystal, glass, wooden, artificial, natural, wool, cotton, polyester, feather, hair, or powder materials, or the like, for the brush, body, container, handle, or other parts of the system. The material/system can be solid, flexible, foldable, modularized, one-piece, elastic, or the like.

The cleaning material can be solid, liquid, gas, powder, mixture, compound, solution, fluid, grains, bulky, concentrated, with water, without water, soap, or the like. The sizes for the system can be from 2 inches to 3 ft, and the components from range of 2 mm to 6 inches, as shown in various figures/appendices, here. The machine can work with solar battery, regular battery, AC or DC current, wire, wireless charging, charging with electromagnetic radiation, contact-less charge station, re-chargeable batteries, or the like.

All the embodiments above can be combined with each other, and there is no limit on the number of combinations for mixing or adding the features mentioned above, or in this disclosure. Any variations of the above teaching are also intended to be covered by this patent application.

1. A cosmetic brush cleaner and dryer system, said system comprising:
a handle;
a holder;
a base;
wherein said handle holds one or more brushes of different sizes;
wherein said handle is located on top of said holder;
wherein said holder is located on top of said base.

2. The cosmetic brush cleaner and dryer system as recited in claim 1, wherein said system comprises: locating rib.

3. The cosmetic brush cleaner and dryer system as recited in claim 1, wherein said system comprises: handle groove.

4. The cosmetic brush cleaner and dryer system as recited in claim 1, wherein said system comprises: an alignment mechanism.

5. The cosmetic brush cleaner and dryer system as recited in claim 1, wherein said base contains cleaning fluid or liquid or pod.

6. The cosmetic brush cleaner and dryer system as recited in claim 1, wherein said base contains water.

7. The cosmetic brush cleaner and dryer system as recited in claim 1, wherein said system comprises: a strap stud.

8. The cosmetic brush cleaner and dryer system as recited in claim 1, wherein said system comprises: a strap.

9. The cosmetic brush cleaner and dryer system as recited in claim 1, wherein said system comprises: a strap hole.

10. The cosmetic brush cleaner and dryer system as recited in claim 1, wherein said system comprises: makeup brush groove.

11. The cosmetic brush cleaner and dryer system as recited in claim 1, wherein said system comprises: makeup brush bristle zone.

12. The cosmetic brush cleaner and dryer system as recited in claim 1, wherein said system comprises: a handle stand.

13. The cosmetic brush cleaner and dryer system as recited in claim 1, wherein said system comprises: a sound indicator or a warning signal module connected to a mobile device.

14. The cosmetic brush cleaner and dryer system as recited in claim 1, wherein said system comprises: a wash indicator LED or light.

15. The cosmetic brush cleaner and dryer system as recited in claim 1, wherein said system comprises: finger grab area.

16. The cosmetic brush cleaner and dryer system as recited in claim 1, wherein said system comprises: a fork and a spindle.

17. The cosmetic brush cleaner and dryer system as recited in claim 1, wherein said system comprises: a bearing and a shaft.

18. The cosmetic brush cleaner and dryer system as recited in claim 1, wherein said system comprises: a motor or agitator or vibrator or oscillator.

19. The cosmetic brush cleaner and dryer system as recited in claim 1, wherein said system comprises: an off-center bearing and an off-center shaft.

20. The cosmetic brush cleaner and dryer system as recited in claim 1, wherein said system comprises: a UV lamp or other light or heat sources for cleaning or drying.
